(19) United States
(12) Patent Application Publication
(10) Pub. No.: US 2013/0173733 A1
(43) Pub. Date: Jul. 4, 2013

(54) CONFIGURABLE WEB SERVICE NOTIFICATION WITH TEMPLATES

(71) Applicants: Mira Vrbaski, Kanata (CA); Lui Chu Yeung, Kanata (CA); Hamdy Farid, Kanata (CA); Allen Robinson, Ottawa (CA)

(72) Inventors: Mira Vrbaski, Kanata (CA); Lui Chu Yeung, Kanata (CA); Hamdy Farid, Kanata (CA); Allen Robinson, Ottawa (CA)

(73) Assignee: Alcatel-Lucent Canada Inc., Ottawa (CA)

(21) Appl. No.: 13/343,357

(22) Filed: Jan. 4, 2012

(51) Int. Cl. G06F 15/16

(52) U.S. Cl. 709/207

(57) ABSTRACT

Various exemplary embodiments relate to a method performed by a policy and charging rules node (PCRN) of generating a notification message. The method may include: defining a notification server profile; defining a notification template including a message body and a variable; defining an action rule including a condition; evaluating the condition of the action rule; determining a result set including an attribute; placing the attribute in the variable to form a notification message; and sending the notification message to the notification server. Various exemplary embodiments relate to a PCRN. The PCRN may include: a context information module; a notification server profile storage; a notification template including a message body and a variable; a rules engine configured to evaluate rules using context information; and an action manager configured to: connect to a server, generate a notification message by placing an attribute in the variable, and send the notification message to the server.

### TECHNICAL FIELD

Various exemplary embodiments disclosed herein relate generally to telecommunications networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks, leading to a less-than-elegant solution. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the Policy and Charging Rules Function (PCRF), Policy and Charging Enforcement Function (PCEF), and Bearer Binding and Event Reporting Function (BBERF) of the EPC. These specifications further provide some guidance as to how these elements interact in order to provide reliable data services and charge subscribers for use thereof.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a policy and charging rules node (PCRN) of generating a notification message. The method may include: defining a notification server profile including an address; defining a notification template including a message body and a variable; defining an action rule including a condition and an action for sending a notification message; evaluating the condition of the action rule using a rules engine; determining, by the rules engine, a result set including a value of an attribute; placing the value of the attribute in the variable to form a notification message; and sending the notification message to the address of the notification server.

In various alternative embodiments, the notification server is a SOAP based web-service server and the step of defining a notification server profile includes: defining an address of the server; defining a SOAP action; and storing authentication information for the SOAP based web-service server.

In various alternative embodiments, the step of defining an action rule includes: defining a condition including a criteria, operator, and value; defining a first action including a server action using the notification server; and defining a second action including a message action using the notification template.

In various alternative embodiments, the method also includes defining a custom attribute including a result context and a rule set. The rules engine may evaluate a rule set and the result set may include attributes matching a result context of the rule set.

In various alternative embodiments, the method also includes: receiving a message from another network node; and updating an attribute stored at the PCRN.

In various alternative embodiments, the step of evaluating the condition of the action rule using a rules engine includes: including the action rule in a rule set; for each condition of the action rule, comparing a criteria attribute with a value based on an operator; and if each condition of the action rule is true, adding the action of the action rule to the result set.

In various alternative embodiments, the steps of defining a notification server profile, defining a notification template, and defining an action rule occur while the PCRN is running and the step of sending a notification message occurs without restarting the PCRN.

Various exemplary embodiments may relate to the above described methods encoded as instructions on a non-transitory machine-readable medium. The non-transitory machine-readable medium may include instructions that if executed by a processor of a network node perform the above described method.

Various exemplary embodiments relate to a policy and rules charging node (PCRN). The PCRN may include: a context information module configured to store attributes related to the state of a network; a notification server storage configured to store information for connecting to a server; a notification template storage configured to store a notification template including a message body and a variable; a rules engine configured to evaluate action rules using context information and select a notification action; and an action manager configured to: connect to a server defined in the notification server profile storage, generate a notification message by placing a value of an attribute in the variable of a notification template, and send the notification message to the server.

In various alternative embodiments, the PCRN also includes a custom rule dictionary configured to store definitions of user created custom attributes including a result context and a rule set.

In various alternative embodiments, the rules engine is configured to evaluate a rule set including one or more action rules and return a result set including attributes that include a result context matching the rule set.

In various alternative embodiments, the PCRN also includes an action rule storage configured to store user created action rules wherein an action rule includes a condition and an action.

In various alternative embodiments, the PCRN also includes a message handler configured to receive a message from another network node via an interface and update an attribute within the context information module based on the received message.

In various alternative embodiments, the PCRN also includes a scanner that generates an action rule object from an action rule defined while the PCRN is running. The rules engine may evaluate the action rule and the action manager may generate a notification message before the PCRN restarts.

It should be apparent that, in this manner, various exemplary embodiments enable a policy and rules charging node (PCRN) for generating notification messages. In particular, by defining notification server profiles, notification templates, custom attributes, and action rules, a PCRN may be able to provide customized notification messages to subscribers either directly or indirectly via external web servers.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates an exemplary policy and charging rules node (PCRN);

FIG. 3 illustrates an exemplary data structure for storing a notification server profile;

FIG. 4 illustrates an exemplary notification template;

FIG. 5 illustrates an exemplary data structure for storing an action rule; and

FIG. 6 illustrates a flowchart showing an exemplary method of sending a notification message.

### DETAILED DESCRIPTION

A policy and charging rules node (PCRN) fulfills an important role in a subscriber network of managing the connections of subscribers. The PCRN receives a variety of information from other nodes in order to make policy decisions. As the PCRN makes policy decisions, it may notify a subscriber about changes in service or the subscription. For example, a PCRN may notify a subscriber when he or she has used a set amount of a usage quota. A service provider may desire flexibility in notifying a subscriber. For example, the service provider may want to choose the method of sending the notification. A service provider may also want to customize the message itself using information available to the PCRN.

Flexible notification may also allow the PCRN to integrate with other devices of the network operator. Rather than sending notification to a subscriber, a network operator may want the PCRN to send notification messages to a web server. A web server may perform additional processing of notification messages. A web server may then send customized notification messages to a subscriber or use the information in the notification message for other purposes such as accounting, statistical analysis, marketing, etc.

In view of the foregoing, it would be desirable to provide a policy and charging rules node (PCRN) for generating notification messages. In particular, it would be desirable to provide a PCRN that may quickly make policy decisions and provide customized notification messages to either subscribers or web servers.

Referring now to the drawings, in which like numerals refer to like components or steps, there are disclosed broad aspects of various exemplary embodiments.

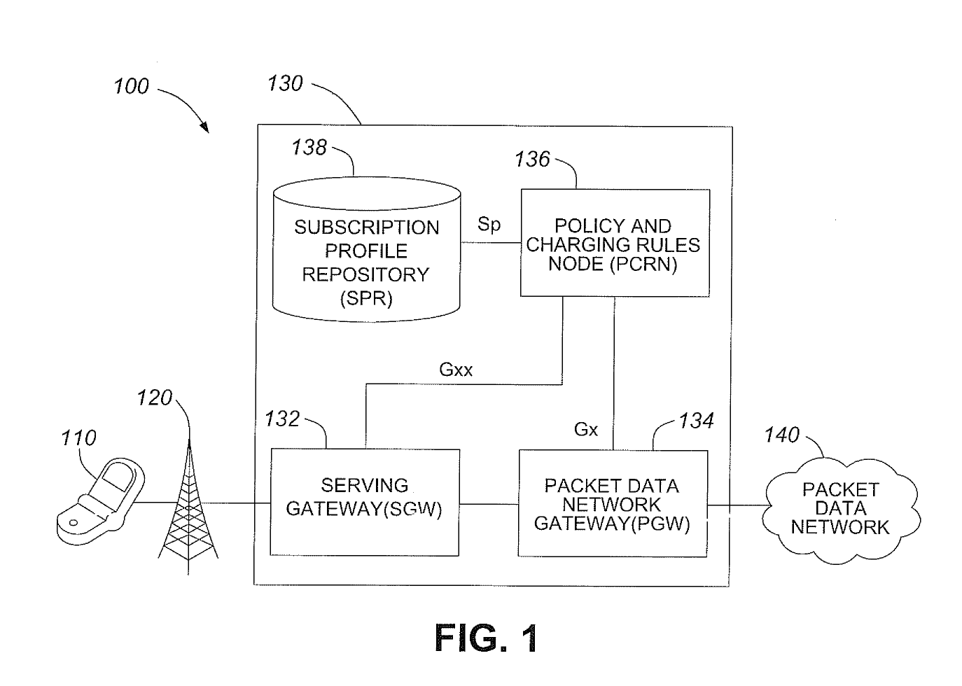

FIG. 1 illustrates an exemplary subscriber network 100 for providing various data services. Exemplary subscriber network 100 may be a communications network, such as an LTE or 4G mobile communications network, for providing access to various services. In various exemplary embodiments, subscriber network 100 is a public land mobile network (PLMN). The subscriber network 100 may include user equipment 110, base station 120, evolved packet core (EPC) 130, and packet data network 140.

User equipment 110 may be a device that communicates with packet data network 140 for providing an end-user with a data service. Such data service may include, for example, voice communication, text messaging, multimedia streaming, and Internet access. More specifically, in various exemplary embodiments, user equipment 110 is a personal or laptop computer, wireless email device, cell phone, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or association of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, a PCRN 136, and a subscription profile repository (SPR) 138.

Serving gateway (SGW) 132 may be a device that provides gateway access to the EPC 130 to an end user of network 100. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the proxy mobile IP (PMIP) standard, SGW 132 may include a bearer binding and event reporting function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140 to an end user of network 100. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. For example, PGW 134 may provide subscriber usage information to PCRN 136 according to armed metering rules determined by PCRN 136. It should be noted that while exemplary network 100 corresponds to one particular implementation of long term evolution (LTE), many variations may exist. For example, SGW 132 may not be present, PGW 134 may not be present, and/or the functions of SGW 132 and PGW 134 may be consolidated into a single device or spread across multiple additional devices.

Policy and charging rules node (PCRN) 136 may make policy decisions based on network information. PCRN 136 may make subscriber metering policy decisions based on subscriber policies, subscriber information, and network usage information. PCRN 136 may include a policy and charging rules function (PCRF) that generates PCC and/or QoS rules for implementing policy decisions. PCRN 136 may communicate with SGW 132 and PGW 134 via a Gxx and a Gx interface, respectively. PCRN 136 may arm SGW 132 and/or PGW 134 with usage reporting rules for desired subscriber usage information. PCRN 136 may generate and/or modify PCC rules to control how SGW 132 and PGW 134 treat subscriber traffic.

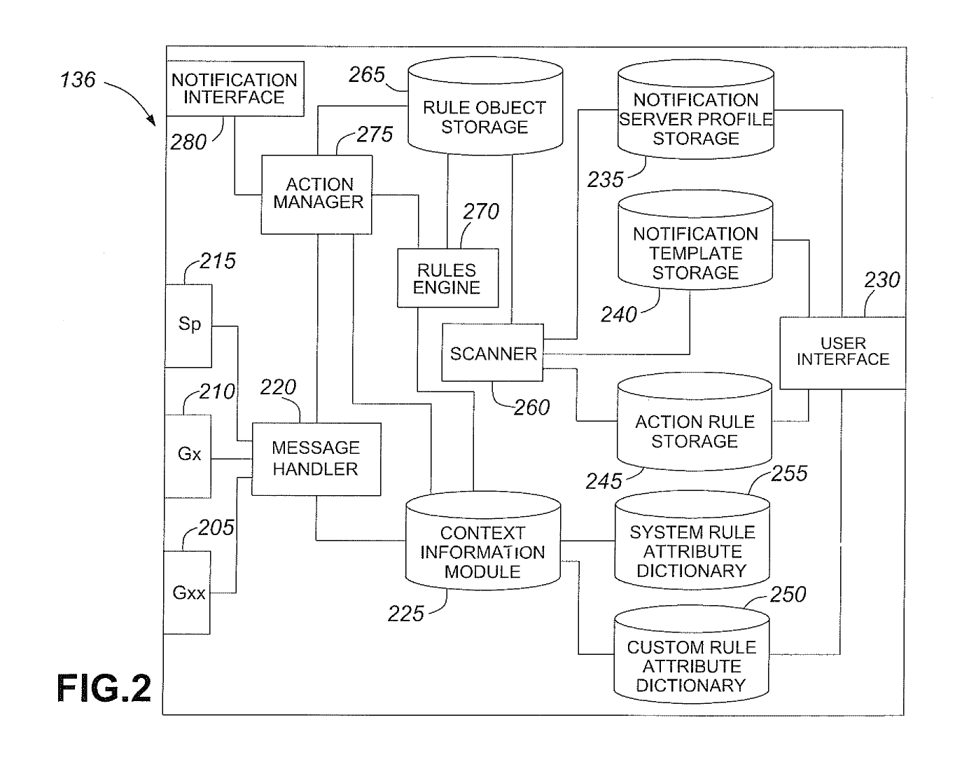

In the process of making policy decisions, PCRN 136 may make use of one or more rule objects to select applicable policies and actions, the details of which will be described below with reference to FIGS. 2-6. PCRN 136 may evaluate rule tables to generate result sets. PCRN 136 may generate customized notification messages based on the result sets.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. Data stored by SPR 138 may include an identifier of each subscriber and indications of subscription information for each subscriber such as, for example, subscriber category, subscriber policies or plans, account balances, bandwidth limits, charging parameters, and subscriber priority. SPR 138 may also maintain a record of current subscriber usage according to one or more counters such as, for example, data volume (uplink, downlink, or total), time, or credits.

Packet data network 140 may be a network (e.g., the Internet or another network of communications devices) for providing data communications between user equipment 110 and other devices connected to packet data network 140. Packet data network 140 may further provide, for example, phone and/or Internet service to various user devices in communication with packet data network 140.

FIG. 2 illustrates an exemplary PCRN 136. PCRN 136 may include Gxx interface 205, Gx interface 210, Sp interface 215, message handler 220, context information module 995, user interface 230, notification server profile storage 235, notification template storage 240, action rule storage 245, custom rule attribute dictionary 250, system rule attribute dictionary 255, scanner 260, rule object storage 265, rules engine 270, action manager 275, and notification interface 280.

Gxx interface 205 may be an interface comprising hardware and/or executable instructions encoded on a machine-readable storage medium configured to communicate with a SGW such as SGW 132. Such communication may be implemented according to the 3GPP TS 29.212. Thus, Gxx interface 205 may receive requests for QoS rules and transmit QoS rules for installation. Gxx interface 205 may further receive UE-originated application requests, session requests, and event notifications in the form of a credit control request (CCR).

Gx interface 210 may be an interface comprising hardware and/or executable instructions encoded on a machine-readable storage medium configured to communicate with a PGW such as PGW 134. Such communication may be implemented according to the 3GPP TS 29.212. Thus, Gx interface 210 may receive requests for PCC rules and transmit PCC rules for installation. Gx interface 210 may further receive UE-originated application requests, session requests, and event notifications in the form of a CCR.

Sp interface 215 may be an interface comprising hardware and/or executable instructions encoded on a machine-readable storage medium configured to communicate with SPR 138. For example, Sp interface 215 may receive subscriber information in the form of a subscriber profile. Sp interface 215 may also send subscriber information or updated subscriber profiles to SPR 138. Sp interface 215 may not be included if SPR 138 is an integrated component of PCRN 136.

Message handler 220 may include hardware and/or executable instructions encoded on a machine-readable storage medium configured to process usage monitoring messages sent and/or received via Gxx interface 205, Gx interface 210, and/or Sp interface 215. For example, message handler 220 may receive usage accounting messages from PGW 134. After PCRN 136 makes a policy decision, message handler 220 may construct and transmit a message over Gxx interface 205, Gx interface 210, and/or Sp interface 215 to notify other nodes as to the result of the policy decision. For example, if PCRN 136 creates a new PCC rule according to an applicable policy, it may construct a reauthorization request (RAR) message to push the new PCC rule to an appropriate PGW. Message handler 220 may provide context information from received messages to rules engine 270, either directly or via context information module 225. Message handler 220 may update attributes stored in context information module 225 with attributes received in a message from another node. Messages received by message handler 220 may also trigger invocation of a rule table to determine whether an action should be taken.

Context information module 225 may include hardware and/or executable instructions encoded on a machine-readable storage medium configured to provide various context information to rules engine 270. Context information may include various system attributes defined by custom rule attribute dictionary 250 and system rule attribute dictionary 255. For example, context information module 225 may store information carried by a subscription-ID attribute of a received message. Context information module 225 may further store previously received and/or transmitted messages associated with a subscriber, session, and/or service data flow. Context information module 225 may further access information stored elsewhere such as, for example, subscriber information stored in an SPR such as SPR 138.

User interface 230 may include hardware and/or executable instructions encoded on a machine-readable storage medium configured to provide a network operator with access to PCRN 136. User interface 230 may receive input from a network operator and may include hardware such as, for example, a keyboard and/or mouse. User interface 230 may also display information as output to the network operator and may include, for example, a monitor. A network operator may access notification server profile storage 235, notification template storage 240, action rule storage 245 and/or custom rule attribute dictionary 250 via user interface 230. User interface 230 may provide a network operator with various options for creating notification server profiles, notification templates, action rules, and attribute definitions.

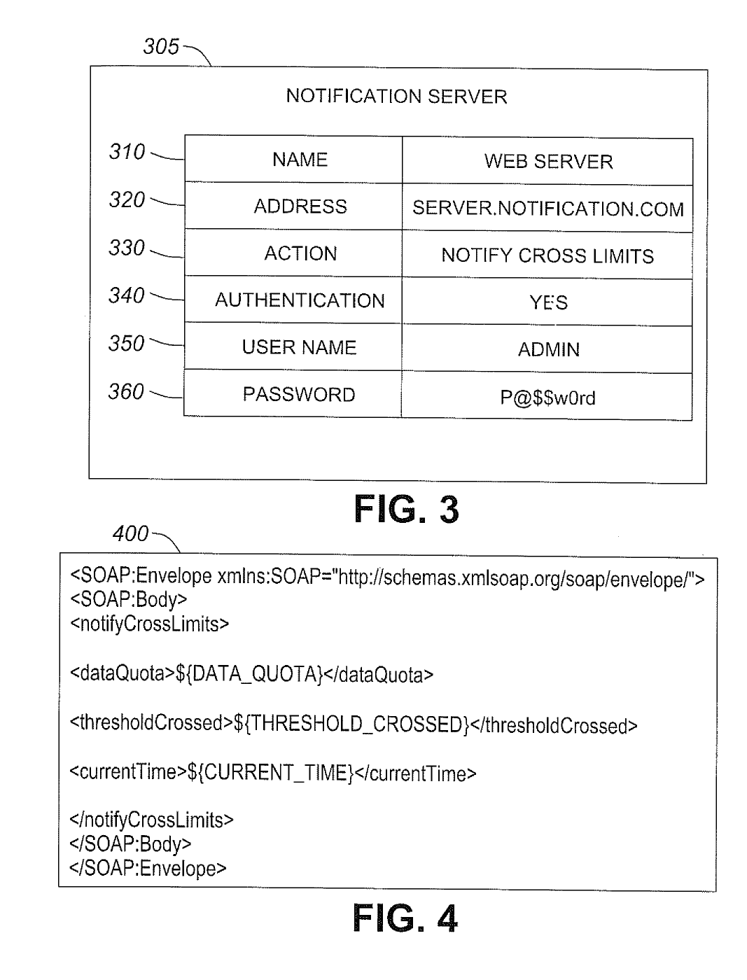

Notification server profile storage 235 may include any machine-readable medium capable of storing notification server profiles for use by PCRN 136. Accordingly, notification server profile storage 235 may include a machine-readable storage medium such as read-only memory (ROM), random-access memory (RAM), magnetic disk storage media, optical storage media, flash-memory devices, and/or similar storage media. PCRN 136 may use various types of notification servers and protocols including: Short Message Service (SMS), email, Extensible Messaging and Presence Protocol (XMPP), Simple Object Access Protocol (SOAP) and Representational State Transfer (REST). As will be described in further detail below with respect to FIG. 3, notification server profile storage 235 may store numerous notification server profiles.

Notification template storage 240 may include any machine-readable medium capable of storing notification templates for use by PCRN 136. Accordingly, notification template storage 240 may include a machine-readable storage medium such as read-only memory (ROM), random-access memory (RAM), magnetic disk storage media, optical storage media, flash-memory devices, and/or similar storage media. Notification template storage 240 may include multiple notification templates.

A notification template may be used for creating a notification message that may be sent to a subscriber or a notification server. A notification template may include a unique template name, a rule system version, and template content. Template content may include a message body and one or more variables. The message body may use different formats. For example, a message body for an SMS message may be a simple text message. In various exemplary embodiments using SOAP messages, the message body may be an XML message complying with SOAP format requirements. A variable may be included within the message body. A variable may indicate a place where a system rule attribute or a custom rule attribute should be inserted into the notification template. A variable may be indicated by an escape symbol and a variable name. In various exemplary embodiments, a variable may be indicated by a dollar sign ($) followed by brackets surrounding the variable name. For example, a simple message template may be: “The time is ${CURRENT_TIMESTAMP}.” The ${CURRENT_TIMESTAMP} may indicate a variable that should be replaced by an attribute defined as CURRENT_TIMESTAMP. As will be described in further detail below with respect to FIG. 4, notification template storage 240 may store SOAP message templates.

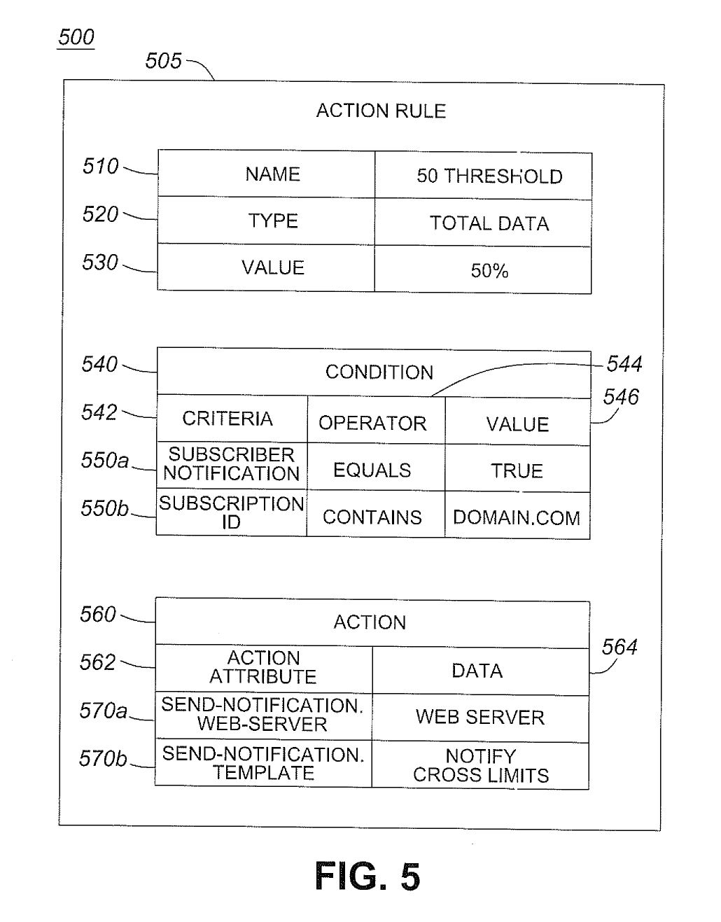

Action rule storage 245 may include any machine-readable medium capable of storing action rules for use by PCRN 136. Accordingly, notification server storage 245 may include a machine-readable storage medium such as read-only memory (ROM), random-access memory (RAM), magnetic disk storage media, optical storage media, flash-memory devices, and/or similar storage media. A network operator may use user interface 230 to create action rules to determine actions performed by PCRN 136. As will be described in further detail below with respect to FIG. 5, action rule storage 245 may store numerous action rules.

Custom rule attribute dictionary 250 may include any machine-readable medium capable of storing attribute definitions for use by PCRN 136. Accordingly, custom rule attribute dictionary 250 may include a machine-readable storage medium such as read-only memory (ROM), random-access memory (RAM), magnetic disk storage media, optical storage media, flash-memory devices, and/or similar storage media. Custom rule attribute dictionary 250 may store attribute definitions. A network operator may use user interface 230 to create custom attribute definitions. A network operator may choose attributes defined in custom rule attribute dictionary 250 when creating action rules.

An attribute definition may define an attribute that may be used by PCRN 136. An attribute may be used as part of a condition or action of a policy rule. In various exemplary embodiments, an attribute definition may be defined using XML. The attribute definition may define a name, value type, one or more result contexts, access restrictions, and a domain name for a custom rule attribute. A result context may include one or more rule sets. When the rules engine 270 evaluates a rule set, it may return the attribute as part of a result context.

As an example of a custom rule attribute, a network operator may define a language attribute that indicates a preferred language of a subscriber. The language attribute may be associated with rule sets for managing subscriber sessions and monitoring usage. PCRN 136 may include a language variable in, for example, a SOAP message template, and replace the variable with the language attribute of a subscriber when sending a SOAP message. A SOAP server may then process the SOAP message to generate a notification in the correct language. Alternatively, PCRN 136 may use the language attribute to select a template in the correct language. A network operator may create other custom attributes to store any information that may be useful.

System rule attribute dictionary 255 may include any machine-readable medium capable of storing attribute definitions for use by PCRN 136. Accordingly, system rule attribute dictionary 255 may include a machine-readable storage medium such as read-only memory (ROM), random-access memory (RAM), magnetic disk storage media, optical storage media, flash-memory devices, and/or similar storage media. System rule attribute dictionary 255 may store attribute definitions that are necessary for the basic operation of PCRN 136. For example, system rule attribute dictionary 255 may include attributes corresponding to Diameter attribute value pairs (AVP) defined by the 3GPP specifications. System rule attribute dictionary may also include action attributes that define actions to be performed by PCRN 136. Action attributes for notification may include a notification server action that causes PCRN 136 to connect to a server and a notification template action that causes PCRN 136 to send a notification message to a server. System rule attribute dictionary 255 may be preconfigured and require no additional configuration by a network operator. A network operator may choose attributes defined in system rule attribute dictionary 255 when creating action rules or message templates.

Scanner 260 may include hardware and/or executable instructions encoded on a machine-readable storage medium configured to generate rule objects from notification server profile storage 235, notification template storage 240, and action rule storage 245. A rule object may be processed by rules engine 270. Scanner 260 may generate rule objects on system startup, during a rule version change, or during run time. Scanner 260 may generate rule tables that may be used by rules engine 270 to select action rules. Action rules for notification may be included in a rule set for performing other tasks at PCRN 136 and may be included in a rule table for that rule set. Scanner 260 may include newly generated rule objects in rule tables during run-time so that the new rules may be evaluated without requiring a reset of PCRN 136.

Rule object storage 265 may be any machine-readable medium capable of storing rule objects for use by rules engine 270. Accordingly, rule object storage 265 may include a machine-readable storage medium such as read-only memory (ROM), random-access memory (RAM), magnetic disk storage media, optical storage media, flash-memory devices, and/or similar storage media. Rule object storage may store rule objects such as action rules or rule tables. Rule object storage 265 may include a cache for storing rule objects that are used frequently.

Rules engine 270 may include hardware and/or executable instructions on a machine-readable storage medium configured to evaluate a rule set and return a result set. A rule set may be organized as a collection rule tables. Each rule table may include one or more rules. Each rule may include conditions and actions. Rule sets, rule table, and rules may be stored in rule object storage 265. A rule set may be evaluated by rules engine 270 at specific execution points of the PCRN 136. Rules engine 270 may evaluate the conditions for each rule and, if all conditions of a rule are true, add the actions to a result set. Conditions may be based on context information provided by context information module 225 and/or system parameters. Actions may include a rule object that may be added to another rule table or an action attribute. Once rules engine 270 has evaluated each rule in a rule table, the result set may be passed to action manager 275. Rules engine 270 may be used to perform other tasks within PCRN 136, and each task may be allocated an actual or virtual instance of rules engine 270.

Action manager 275 may perform PCRN actions included in the result set. In particular, action manager 275 may generate notification messages according to action rules. Action manager 275 may send notification messages in several steps. First, action manager 275 may execute a notification server action to establish a connection with a notification server indicated in the action rule. Action manager 275 may retrieve notification server information from notification server profile storage 235 or rule object storage 265. Action manager 275 may connect to a notification server using notification interface 280 and information for the notification server. Second, action manager 275 may generate the notification message. Action manager 275 may retrieve the notification template indicated in the action rule. Action manager 275 may then form a notification message by replacing variables in the notification template with attributes in the result set. Finally, action manager 275 may send the notification message to the notification server.

Action manager 275 may also generate or update QoS and/or PCC rules to provide the subscriber with correct service according to the policy. Action manager 275 may also update context information module 225, SPR 138, or other stored data. Action manager 275 may use message handler 220 to forward updated rules to network components such as SGW 132 and PGW 134.

Notification interface 280 may be an interface comprising hardware and/or executable instructions encoded on a machine-readable storage medium configured to communicate with a web server. Notification interface 280 may be a network interface controller. Communication through notification interface 280 may be implemented according to any protocol used by the server. For example, notification interface 280 may communicate with servers including: Short Message Service (SMS), email, Extensible Messaging and Presence Protocol (XMPP), Simple Object Access Protocol (SOAP) and Representational State Transfer (REST). Notification interface 280 may communicate with a web server located in packet data network 140. Alternatively, notification interface 280 may communicate with a web server located within EPC 130.

FIG. 3 illustrates an exemplary data structure 300 for storing a notification server profile 305. It should be apparent that data structure 300 may be implemented using a variety of data structures such as, for example, objects, arrays, linked lists, or trees. Data structure 300 may be stored in notification server profile storage 235 or another computer-readable storage medium accessible to PCRN 136.

Notification server profile 305 may store information related to a notification server such as a web server providing a SOAP web service. Notification server profile 305 may include multiple fields for storing information about a notification server. Notification server profile 305 may include: name field 310, address field 320, action field 330, authentication field 340, user name field 350, and password field 360. Notification server profile 305 may include other fields that are useful for defining various notification servers.

Name field 310 may indicate a name or other unique identifier of the notification server. For example, name field 310 may indicate that a server is named “Web Server.” Address field 320 may indicate an address of the notification server. Address field 320 may include an IP address, URL, or other method of addressing a server. For example, address field 320 may indicate that the notification server is located at server.notification.com. Action field 330 may indicate an action that may be performed by the notification server. For example, action field 330 may indicate a SOAP action that is performed by a SOAP web server. For example, action field 330 may indicate that the notification server can perform a “notify cross limits” action. Authentication field 340 may indicate a type of authentication used by the notification server. Authentication field 340 may indicate whether authentication is used or designate an authentication protocol used by the notification server. For example, authentication field 340 may simply indicate that authentication is used. User name field 350 may indicate authentication information such as a user name that is required to use the notification server. For example, user name field 350 may indicate that the user name “ADMIN” should be used to authenticate to the notification server. Password field 360 may indicate authentication information such as a password that is required to use the notification server. For example, password field 360 may indicate that the password “P@$$w0rd” is required to use the notification server.

FIG. 4 illustrates an exemplary notification template 400. Exemplary notification template 400 may be stored in notification template storage 240 or another computer-readable storage medium accessible to PCRN 136. Notification template 400 may be a SOAP notification template. Notification template 400 may include XML tags and be validated according to an XML schema. Notification template 400 may include a name or address of a schema used to validate the template. For example, notification template 400 may be evaluated according to a schema located at http://schemas.xmlsoap.org/soap/envelope. Notification template 400 may include a SOAP body and include an action. For example, notification template 400 may include an action named “notifyCrossLimits.” Notification template 400 may also include one or more variables. For example, notification template 400 nay include variables ${DATA_QUOTA}, ${THRESHOLD_CROSSED}, and ${CURRENT_TIME}. Values of attributes may be placed into the variables to form a notification message based on notification template 400. A SOAP based web-service server may interpret the notification message and generate a message to a subscriber.

FIG. 5 illustrates an exemplary data structure 500 for storing an action rule 505. It should be apparent that data structure 500 may be implemented using a variety of data structures such as, for example, objects, arrays, linked lists, or trees. Data structure 500 may be stored in action rule storage 245 or another computer-readable storage medium accessible to PCRN 136.

Action rule 505 may define an action rule used by rules engine 270 to make policy decisions at PCRN 136. PCRN 136 may use a variety of action rules for providing notification to subscribers. As an example, action rule 505 may be a metering threshold that is used to provide notification to subscribers. Other action rules used to make policy decisions, for example, network security rules, network management rules, and session management rules may also include notification actions for providing notification. Action rule 505 may include various fields for storing information. Action rule 505 may include name field 510, type field 520, value field 530, condition field 540, and action field 560.

Name field 510 may indicate a name or other unique identifier of the action rule. For example, name field 510 may indicate that the action rule is named “50Threshold.” Threshold type field 520 may indicate a type of threshold that is being measured. For example, threshold type field 520 may indicate that total data usage may be measured against a threshold. Value field 530 may indicate a value of the threshold that will trigger the action rule if exceeded. Value field 530 may indicate a value of the threshold type, or may be a percentage of another value. For example, value field 530 may indicate that exceeding a threshold of 50% of a data quota will trigger the action rule. The type field 520 and value field 530 of the action rule 505 may be considered an implicit condition. In various alternative embodiments, an implicit threshold condition may be included as an explicit condition in conditions 540.

Condition field 540 may indicate zero or more explicit conditions that must be true for the action rule to be performed. Conditions field 540 may include for each condition: criteria field 542, operator field 544, and value field 546. Rules engine 270 may compare a criteria 542 and a value 546 using an operator 544. Criteria field 542 may include an attribute, message, or other data item stored at PCRN 136. Operator 544 may include an operator that can be evaluated to provide a logical true or false answer. Exemplary operators include: equals, greater than, less than, contains, not and other logical operators. Value 546 may include an attribute or an actual numerical or logical value. As examples, action rule 505 may include conditions 550a and 550b. Condition 550a may indicate a criteria of a subscriber notification attribute, an operator of equals, and a value of true. Rules engine 270 may determine that the condition 550a is true when a subscriber notification attribute equals true. As a second example, condition 550b may indicate a criteria of a Gx Subscription. ID, an operator of contains, and a value of “domain.com.” Rules engine 270 may determine that condition 550b is true when a subscriber ID, such as an NAI, includes a local domain.

Action field 560 may indicate one or more actions that should be performed by action manager 270 when the conditions 540 are true. Each action may include an action attribute 562 and data 564. The action attribute may define the action that is to be performed by the PCRN 136. Data 564 may indicate data that PCRN 136 may use when performing the action. As shown by exemplary actions 570a and 570b, notification may be performed using actions. Action 570a may indicate an action of connecting to a webserver. The Send-Notification.Web-Server action may indicate that PCRN 136 should retrieve a notification server profile and connect to the notification server. Action 570a may indicate that the notification server profile 305 named WebServer should be used. Action 570b may indicate an action of sending a notification message to the notification server. The Send-Notification.Template action may indicate that PCRN 136 should generate a notification message based on a template. Action 570b may indicate that a template named notifyCrossLimits should be used.

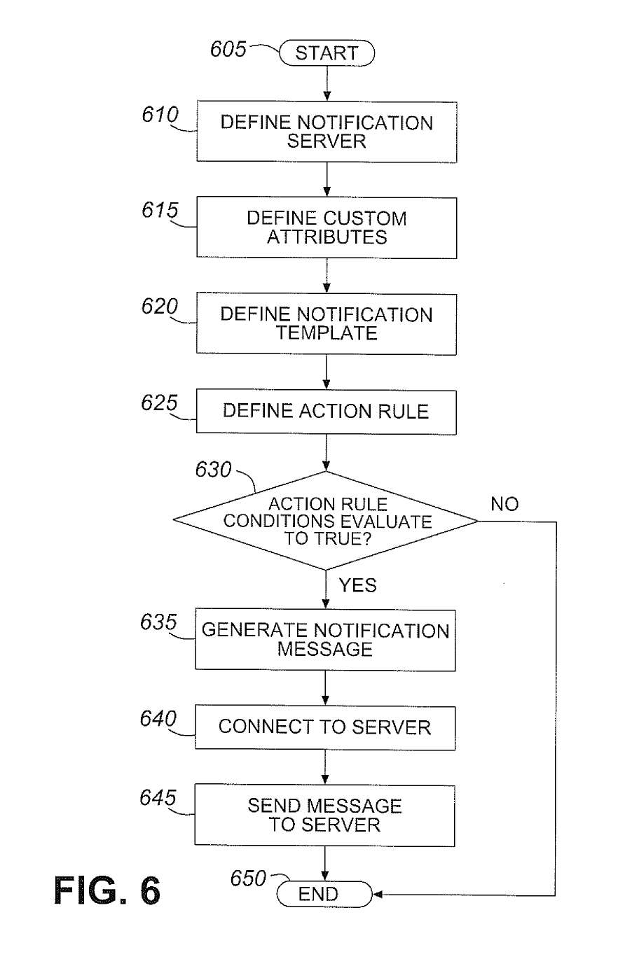

FIG. 6 illustrates a flowchart showing an exemplary method 600 of sending a notification message. Method 600 may be performed by the various components of PCRN 136 including: message handler 220, user interface 230, scanner 260, rules engine 270, and action manager 275. Method 600 may begin at step 605 and proceed to step 610.

In step 610, a network operator may use PCRN 136 to define a notification server. PCRN 136 may use user interface 130 to present a network operator with options for creating a notification server profile. The network operator may select options and provide information. PCRN 136 may generate a notification server profile and store the profile in notification server profile storage 235. The method may then proceed to step 615.

In step 615, a network operator may use PCRN 136 to define custom attributes. PCRN 136 may use user interface 130 to present a network operator with options for configuring custom attributes. Alternatively, PCRN 136 may provide a method for editing an XML file including custom attribute definitions. PCRN 136 may store the custom attribute definitions in custom rule attribute dictionary 250. The method may then proceed to step 620.

In step 620, a network operator may use PCRN 136 to define a notification template. PCRN 136 may use user interface 230 to present a network operator with options for configuring a notification template. For example, PCRN 136 may allow a network operator to select attributes to be used as variables within a notification template. Alternatively, PCRN 136 may provide a method of editing a text file or XML file for a template. PCRN 136 may also provide version control and validation testing. PCRN 136 may store the notification template in notification template storage 240. The method may then proceed to step 625.

In step 625, the network operator may use PCRN 136 to define an action rule. PCRN 136 may use user interface 230 to provide options for configuring an action rule. For example, PCRN 136 may allow a network operator to select the criteria, operators, and values of the conditions. PCRN 136 may also allow a network operator to select the action attributes and data used to provide a notification message. PCRN 136 may allow a user to select attributes from custom rule attribute dictionary 250 and/or system rule attribute dictionary 255. The method may then proceed to step 630.

In step 630, PCRN 136 may evaluate a rule set using rules engine 270. Rules engine 270 may determine whether the conditions in each action rule evaluate to true. If all the conditions of the action rule are true, the method may proceed to step 635. If one of the conditions is not true, the actions may not be performed and the method may proceed to step 650, where the method ends.

In step 635, PCRN 136 may generate a notification message based on a notification template. PCRN 136 may substitute variables in the template with attribute values in the result set. The method may then proceed to step 640.

In step 640, PCRN 136 may connect to a server. PCRN 136 may use information stored in notification server profile storage 235 to establish a connection with the server. PCRN 136 may authenticate using information stored in a notification server profile. The method may then proceed to step 645.

In step 645, PCRN 136 may send the notification message to the server. The server may forward the message to a client, or may perform additional processing on the message. For example, an email server may simply forward an email message to the subscriber. As another example, a SOAP server may process a SOAP message and generate an entirely different message for the subscriber. A SOAP server may also perform processing of the message without sending notification to a subscriber. Once the message has been sent to a server, the method may proceed to step 650 where the method ends.

According to the foregoing, various exemplary embodiments provide for a policy and rules charging node (PCRN) for generating notification messages about the status of the network or a subscriber. In particular, by defining notification server profiles, notification templates, custom attributes, and action rules, a PCRN may be able to provide customized notification messages to either subscribers or web servers.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a policy and charging rules node (PCRN) of generating a notification message, the method comprising:
defining a notification server profile including an address;
defining a notification template including a message body and a variable;
defining an action rule including a condition and an action for sending a notification message;
evaluating the condition of the action rule using a rules engine;
determining, by the rules engine, a result set including a value of an attribute;
placing the value of the attribute in the variable to form a notification message; and
sending the notification message to the address of the notification server.

2. The method of claim 1, wherein the notification server is a SOAP based web-service server and the step of defining a notification server profile comprises:
defining an address of the server;
defining a SOAP action; and
storing authentication information for the SOAP based web-service server.

3. The method of claim 1, wherein the step of defining an action rule comprises:
defining a condition including a criteria, operator, and value;
defining a first action including a server action using the notification server; and
defining a second action including a message action using the notification template.

4. The method of claim 1, further comprising defining a custom attribute including a result context and a rule set, wherein the rules engine evaluates a rule set and the result set includes attributes matching a result context of the rule set.

5. The method of claim 1, further comprising:
receiving a message from another network node; and
updating an attribute stored at the PCRN.

6. The method of claim 1, wherein the step of evaluating the condition of the action rule using a rules engine comprises:
including the action rule in a rule set;
for each condition of the action rule, comparing a criteria attribute with a value based on an operator; and
if each condition of the action rule is true, adding the action of the action rule to the result set.

7. The method of claim 1, wherein the steps of defining a notification server profile, defining a notification template, and defining an action rule occur while the PCRN is running and the step of sending a notification message occurs without restarting the PCRN.

8. A policy and rules charging node (PCRN) comprising:
a context information module configured to store attributes related to the state of a network;
a notification server profile storage configured to store information for connecting to a server;
a notification template storage configured to store a notification template including a message body and a variable;
a rules engine configured to evaluate action rules using context information and select a notification action; and
an action manager configured to:
connect to a server defined in the notification server storage,
generate a notification message by placing a value of an attribute in the variable of a notification template, and
send the notification message to the server.

9. The PCRN of claim 8, further comprising a custom rule dictionary configured to store definitions of user created custom attributes including a result context and a rule set.

10. The PCRN of claim 8, wherein the rules engine is configured to evaluate a rule set including one or more action rules and return a result set including attributes that include a result context matching the rule set.

11. The PCRN of claim 8, further comprising an action rule storage configured to store user created action rules wherein an action rule includes a condition and an action.

12. The PCRN of claim 8, further comprising a message handler configured to receive a message from another network node via an interface and update an attribute within the context information module based on the received message.

13. The PCRN of claim 8, further comprising a scanner that generates an action rule object from an action rule defined while the PCRN is running, wherein the rules engine evaluates the action rule and the action manager generates a notification message before the PCRN restarts.

14. A tangible and non-transitory machine-readable storage medium encoded with instructions thereon for execution by a network element of a telecommunication network, wherein said tangible and non-transitory machine-readable storage medium comprises:
instructions for defining a notification server profile including an address;
instructions for defining a notification template including a message body and a variable;
instructions for defining an action rule including a condition and an action for sending a notification message;
instructions for evaluating the condition of the action rule using a rules engine;
instructions for determining, by the rules engine, a result set including a value of an attribute;
instructions for placing the value of the attribute in the variable to form a notification message; and
instructions for sending the notification message to the address of the notification server.

15. The tangible and non-transitory machine-readable storage medium of claim 14, wherein the notification server is a SOAP based web-service server and the instructions for defining a notification server profile comprise:
instructions for defining an address of the server;
instructions for defining a SOAP action; and
instructions for storing authentication information for the SOAP based web-service server.

16. The tangible and non-transitory machine-readable storage medium of claim 14, wherein the instructions for defining an action rule comprise:
instructions for defining a condition including a criteria, operator, and value;
instructions for defining a first action including a server action using the notification server; and
instructions for defining a second action including a message action using the notification template.

17. The tangible and non-transitory machine-readable storage medium of claim 14, further comprising instructions for defining a custom attribute including a result context and a rule set, wherein the rules engine evaluates a rule set and the result set includes attributes matching a result context of the rule set.

18. The tangible and non-transitory machine-readable storage medium of claim 14, further comprising:
instructions for receiving a message from another network node; and
instructions for updating an attribute stored at the PCRN.

19. The tangible and non-transitory machine-readable storage medium of claim 14, wherein the instructions for evaluating the condition of the action rule using a rules engine comprise:
instructions for including the action rule in a rule set;
instructions for comparing a criteria attribute with a value based on an operator for each condition of the action rule; and
instructions for adding the action of the action rule to the result set if each condition of the action rule is true.

20. The tangible and non-transitory machine-readable storage medium of claim 14, wherein the instructions for defining a notification server profile, defining a notification template, and defining an action rule are executed while the PCRN is running and the instructions for sending the notification method are executed without restarting the PCRN.
